(19) United States
(12) Patent Application Publication
(10) Pub. No.: US 2016/0300094 A1
(43) Pub. Date: Oct. 13, 2016

(54) SKIN TEXTURE COLLECTION AND IDENTITY RECOGNITION METHOD AND SYSTEM

(71) Applicant: ZHEJIANG WELLCOM TECHNOLOGY CO., LTD., Hangzhou City, Zhejiang (CN)

(72) Inventors: Jie LU, Zhejiang (CN); Jianjun ZOU, Zhejiang (CN); Xuxiao HU, Zhejiang (CN); Shengguo WANG, Zhejiang (CN)

(21) Appl. No.: 15/036,275

(22) PCT Filed: Mar. 14, 2014
(86) PCT No.: PCT/CN2014/073446

§ 371 Date: May 12, 2016

(30) Foreign Application Priority Data
Nov. 12, 2013 (CN) 201310560531.1
Nov. 12, 2013 (CN) 201310562033.0

(51) Int. Cl. G06K 9/00

(52) U.S. Cl. CPC G06K 9/001; G06K 9/00067

(57) ABSTRACT

This application discloses a skin texture collection and identity recognition method. The method includes: collecting a skin texture image of a user; determining a quality weighted value of the skin texture image; comparing the skin texture image with a preset template image to determine a skin texture comparison value; multiplying the quality weighted value by the skin texture comparison value to obtain a multiplication result; and judging whether the multiplication result is greater than a first preset value, and, if yes, than to determine that the identity of the user is to be legitimate. In the examples, due to the facts that minutiae do not need to be emphasized excessively, and texture and large joints are emphasized, the problem that login is rejected due to the lack of the minutiae is reduced.

### TECHNICAL FIELD

This application claims priorities to Chinese Application No. 201310560531.1, titled “Identity Recognition Method and System Based on Skin Texture Characteristics,” filed to The Patent Office of the People's Republic of China, on Nov. 12, 2013, and Chinese Application No. 201310562033.0, titled “Skin Texture Collection and Identity Recognition Method and System,” filed to The Patent Office of the People's Republic of China, on Nov. 12, 2013, the contents of which are incorporated herein by reference in their entireties.

### BACKGROUND ART

Recognition by biological characteristics comprises features of forgery prevention, portability, insusceptibility to loss, insusceptibility to forgetting, and the like, and therefore technologies in this regard have wide applications in industries such as finance, security, insurance, social security, e-business, office automation, ID card management, and forgery prevention.

The existing mature recognition technologies of biological characteristics include those by fingerprints, irides, voiceprints, human faces, hand shapes, palm prints, and the like. Recognition of different biological characteristics each has different features, and fingerprint recognition is superior to those by irides, voiceprints, human faces, hand shapes, palm prints, and the like, in terms of recognition rate and operating efficiency. At present, in fingerprint recognition at home and abroad, the most prevalent and also the most critical technology is a minutiae algorithm, and the core of this technology is extraction and comparison of minutiae. However, there are currently a small percentage of people whose fingerprint images have only a small number of minutiae due to reasons such as biological reasons and interference during the collection. For these people, the possibility of successful match employing the minutiae algorithm is excluded in principle, thereby causing login rejection and influencing regular service for the users.

### SUMMARY OF THE INVENTION

In view of this, this application provides a skin texture collection and identity recognition method and system for use in resolution of the problem of the frequent appearance of login rejection in the existing recognition methods due to few or no minutiae.

In order to achieve the above objective, a solution is now proposed as follows:

A skin texture collection and identity recognition method, including:

collecting a skin texture image of a user;

determining a quality weighted value of the skin texture image;

comparing the skin texture image with a preset template image to determine a skin texture comparison value; and

multiplying the quality weighted value by the skin texture comparison value to obtain a multiplication result, and judging whether the multiplication result is greater than a first preset value, and, if yes, the identity of the user is determined to be legitimate.

Preferably, the comparison of the skin texture image with the preset template image to determine the skin texture comparison value includes in particular:

correcting the skin texture image with the preset template image as a standard; and

comparing the corrected skin texture image with the template image to obtain a skin texture comparison value.

Preferably, the collection of a skin texture image of a user includes in particular:

contacting an active skin texture information collection module with a skin surface requiring the collection of skin texture;

clicking a button to start the collection; and giving a prompt by the system, to indicate completion of the collection.

Preferably, the process of comparison of the corrected skin texture image with the template image to obtain the skin texture comparison value includes in particular:

subjecting the corrected skin texture image and the template image to Fourier transformation respectively to obtain two corresponding sets of values;

obtaining conjugate values of values of any set of the two sets of values obtained above by the Fourier transformation;

performing operation of point multiplication on the conjugate values with values obtained by Fourier transformation of the other image, and normalizing results from the point multiplication; and

subjecting the normalized results from the point multiplication to Fourier inverse transformation, obtaining the maximum value of the absolute values, and determining the maximum value as the skin texture comparison value.

Preferably, after the determination of the quality weighted value of the skin texture image, pre-processing, which includes normalization, filtration, and stretch of the skin texture image, is further included.

Preferably, the correction performed on the skin texture image includes: angle correction and/or displacement correction.

Preferably, the comparison of the skin texture image with the preset template image to determine the skin texture comparison value includes in particular:

comparing the skin texture image with template images in a preset skin texture image template library respectively to obtain comparison results, where the skin texture image template libraries include at least one template image; and

determining the maximal value among the multiple comparison results as the skin texture comparison value.

Preferably, the process of comparison of the skin texture image with the template images in the preset skin texture image template library respectively to obtain the comparison results includes in particular:

subjecting the skin texture image and the template image to Fourier transformation respectively to obtain two corresponding sets of values;

obtaining conjugate values of values of any set of the two sets of values obtained above by the Fourier transformation;

performing operation of point multiplication on the conjugate values with values obtained by Fourier transformation of the other image, and normalizing results from the point multiplication; and

subjecting the normalized results from the point multiplication to Fourier inverse transformation, obtaining the maximum value of the absolute values, and determining the maximum value as the comparison result.

Preferably, the process of comparison of the skin texture image with the template images in the preset skin texture image template library respectively to obtain the comparison results includes in particular:

extracting different skin texture characteristics with regard to the skin texture image;

constituting a characteristic vector from the multiple different skin texture characteristics;

extracting different skin texture characteristics with regard to the template image;

constituting a characteristic vector of the template from the multiple different skin texture characteristics to which the template image corresponds;

comparing the characteristic vector with the characteristic vector of the template to obtain a characteristic-based comparison value; and

normalizing the characteristic-based comparison value and determining the normalized characteristic-based comparison value as the comparison result.

Preferably, the process of comparison of the skin texture image with the template images in the preset skin texture image template library respectively to obtain the comparison results includes in particular:

extracting different skin texture characteristics with regard to the skin texture image;

constituting a characteristic vector from the multiple different skin texture characteristics;

extracting different skin texture characteristics with regard to the template image;

constituting a characteristic vector of the template from the multiple different skin texture characteristics to which the template image corresponds;

comparing the characteristic vector with the characteristic vector of the template to obtain a characteristic-based comparison value;

normalizing the characteristic-based comparison value, to obtain a characteristic-based comparison value;

subjecting the skin texture image and the template image to Fourier transformation respectively to obtain two corresponding sets of values;

obtaining conjugate values of values of any set of the two sets of values obtained above by the Fourier transformation;

performing operation of point multiplication on the conjugate values with values obtained by Fourier transformation of the other image and normalizing results from the point multiplication;

subjecting the normalized results from the point multiplication to Fourier inverse transformation, obtaining the maximum value of the absolute values, and determining the maximum value as the characteristic-related value; and

weighting the characteristic-based comparison value and the characteristic-related value, with a weight coefficient between 0 and 1 and including 0 and 1, and determining the weighted value as the comparison result.

Preferably, before the comparison of the skin texture image with the template images in the preset skin texture image template library respectively to obtain the comparison results, the following step is further included:

performing pre-processing, which includes normalization, filtration, angle correction, displacement correction, and stretch, on the skin texture image.

Preferably, the determination of the quality weighted value of the skin texture image includes in particular:

calculating regularity of the skin texture, calculating energy focusability of the skin texture, calculating the degree of balance of the skin texture, and/or calculating uniformity of the skin texture; and

weighting the regularity of the skin texture, the energy focusability of the skin texture, the degree of balance of the skin texture, and/or the uniformity of the skin texture, to obtain a weighted value.

A skin texture collection and identity recognition system, including:

a skin texture information collection module, configured to collect a skin texture image of a user;

an image quality judgement module, connected with the skin texture information collection module, and configured to determine the quality weighted value of the skin texture image;

a skin texture comparison value determination module, connected with the image quality judgement module, and configured to compare the skin texture image with a preset template image, to determine a skin texture comparison value; and

an identity determination module, connected with the skin texture comparison value determination module, and configured to multiply the quality weighted value by the skin texture comparison value to obtain a multiplication result and to judge whether the multiplication result is greater than a first preset value, and, if yes, to than determine that the identity of the user is to be legitimate.

Preferably, the skin texture comparison value determination module includes: an image correction module and a first skin texture information identification module, where,

the image correction module is connected with the image quality judgement module and configured to correct the skin texture image with the preset template image as a standard; and

the first skin texture information identification module is connected with the image correction module and configured to compare the corrected skin texture image with the template image to obtain a skin texture comparison value.

Preferably, the system further includes:

a skin texture image pre-processing module, with one end connected with the image quality judgement module and the other end connected with the image correction module, configured to pre-process the skin texture image.

Preferably, the image correction module includes: an angle correction submodule and a displacement correction submodule.

Preferably, the skin texture information collection module is an active skin texture information collection module.

Preferably, the active skin texture information collection module is connected to a host computer with a wire therebetween or with a wireless mode.

Preferably, the skin texture comparison value determination module includes: a second skin texture information identification module connected with the image quality judgement module and configured to compare the skin texture image with template images in a preset skin texture image template library respectively to obtain comparison results, and to determine the skin texture comparison value from the multiple comparison results.

Preferably, the system further includes:

a skin texture image pre-processing module, with one end connected with the image quality judgement module and the other end connected with the second skin texture information identification module, configured to pre-process the skin texture image.

Preferably, the image quality judgement module includes:

a regularity-aided image quality judgement submodule, configured to perform judgement on the image quality in terms of regularity;

an energy focusability-aided image quality judgement submodule, configured to perform judgement on the image quality in terms of energy focusability;

a parallelism-aided image quality judgement submodule, configured to perform judgement on the image quality in terms of parallelism; and

a uniformity-aided image quality judgement submodule, configured to perform judgement on the image quality in terms of uniformity.

As can be seen from the above technical solutions that the solutions disclosed in this application determine the user's identity by collecting a skin texture image, weighting the quality of the collected skin texture image, then obtaining a skin texture comparison value by comparison of skin textures of the skin texture image and a prestored template image, and finally taking into consideration the weighted value of the image quality and the skin texture comparison value in conjunction. This application dose not place excess emphasis on minutiae, but places emphasis on texture and large joints, and thus solves the formidable and difficult problem with comparison methods of fingerprint minutiae, of login rejection due to fingerprint images with few or no minutiae.

### DESCRIPTION OF THE DRAWINGS

In order to more clearly illustrate technical solutions within examples of this application or within the prior art, accompanying drawings that are required to be used in the description of the examples or the prior art will be introduced briefly below. Apparently, the accompanying drawings in the following description are merely some examples of this application, and other accompanying drawings can be further obtained according to these accompanying drawings under the premise that no creative labor is made for those of ordinary skill in the art.

FIG. 1 is a flow chart of a skin texture collection and identity recognition method disclosed in examples of this application;

FIG. 2 is a flow chart of another skin texture collection and identity recognition method disclosed in examples of this application;

FIG. 3 is a flow chart of comparison of a skin texture image with a template image disclosed in examples of this application;

FIG. 4 is a flow chart of yet another skin texture collection and identity recognition method disclosed in examples of this application;

FIG. 5 is a flow chart of a method for determining a quality weighted value of a skin texture image disclosed in examples of this application;

FIG. 6 is a flow chart of a method of angle correction after texture extension of a skin texture image disclosed in examples of the application;

FIG. 7 is a flow chart of a method of displacement correction after texture extension of a skin texture image disclosed in examples of this application;

FIG. 8 is a structural diagram of a skin texture collection and identity recognition system disclosed in examples of this application;

FIG. 9 is a structural diagram of another skin texture collection and identity recognition system disclosed in examples of this application;

FIG. 10 is a structural diagram of another skin texture collection and identity recognition system disclosed in examples of this application;

FIG. 11 is a constitutional diagram of an image quality judgement module disclosed in examples of this application;

FIG. 12 is a constitutional diagram of an image correction module disclosed in examples of this application;

FIG. 13 is a schematic view of a skin texture information collection module and a host computer disclosed in examples of this application;

FIG. 14 is a schematic view of another skin texture information collection module and a host computer disclosed in examples of this application;

FIG. 15 is a flow chart of another skin texture collection and identity recognition method disclosed in examples of this application;

FIG. 16 is a flow chart of comparison of a skin texture image with a template image disclosed in examples of this application;

FIG. 17 is a flow chart of yet another comparison of a skin texture image with a template image disclosed in examples of this application;

FIG. 18 is a flow chart of a further comparison of a skin texture image with a template image disclosed in examples of this application;

FIG. 19 is a flow chart of another skin texture collection and identity recognition method disclosed in examples of this application;

FIG. 20 is a flow chart of another skin texture collection and identity recognition method disclosed in examples of this application;

FIG. 21 is a structural diagram of another skin texture collection and identity recognition system disclosed in examples of this application;

FIG. 22 is a structural diagram of another skin texture collection and identity recognition system disclosed in examples of this application; and

FIG. 23 is a constitutional diagram of a further identity recognition system based on skin texture characteristics disclosed in examples of this application.

### DESCRIPTION OF THE PREFERRED EMBODIMENTS

Technical solutions will be described below clearly and completely in conjunction with accompanying drawings in examples of this application. Apparently, the examples described are merely a part of examples of this application, instead of all examples. Based on the examples in this application, all other examples obtained under the premise that no creative labor is made by those of ordinary skill in the art shall belong to the protection scope of this application.

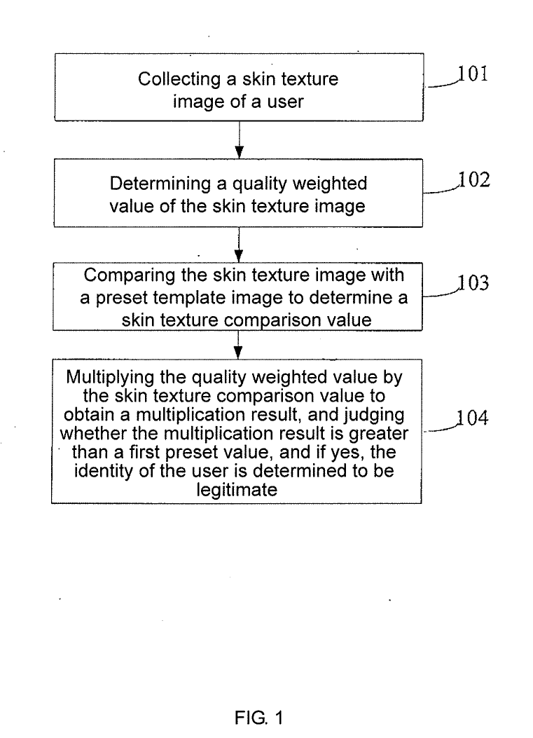

Reference is made to FIG. 1, which is a flow chart of a skin texture collection and identity recognition method disclosed in examples of this application.

As shown in FIG. 1, the method includes:

Step 101: collecting a skin texture image of a user

Particularly, the collection process may include that: first an active skin texture information collection module is contacted with a skin surface requiring the collection of skin texture, then a button on the collection module is clicked to get into a collection link, and when the collection is completed, a prompt is given by the system, indicating that the collection is completed. Herein, the collection sites may be various sites on the skin of human bodies such as the forehead, the back of the hand, and the leg; and the prompt given by the system may be a sound prompt, a light prompt, or a prompt on the screen showing the termination; of course the prompt may also be any combination mode of these three forms.

Step 102: determining a quality weighted value of the skin texture image

Particularly, after the collection of the user's skin texture image, quality of the skin texture image can be judged, and corresponding images are all assigned with weighted values of the image quality. The weighted value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given.

Step 103: comparing the skin texture image with a preset template image to determine a skin texture comparison value

Particularly, the skin texture comparison value can be obtained by the comparison.

Step 104: multiplying the quality weighted value by the skin texture comparison value to obtain a multiplication result, and judging whether the multiplication result is greater than a first preset value, and, if yes, determining that the identity of the user is to be legitimate.

Particularly, a first preset value is prestored prior to the recognition, and the magnitude of the value is determined by the user according to multiple experiments. During the recognition, the quality weighted value of the image and the skin texture comparison value are taken into comprehensive consideration, and the relationship between the multiplication result of the two values and the magnitude of the first preset value is judged. When the multiplication result is greater than the first preset value, the identity of the user is determined to be legitimate, and the user is allowed to login, or else the identity of the user is determined to be illegitimate, and the user is rejected to login.

In this example, due to the facts that minutiae do not need to be emphasized excessively, and texture and large joints are emphasized, the problem that login is rejected due to the lack of the minutiae is reduced.

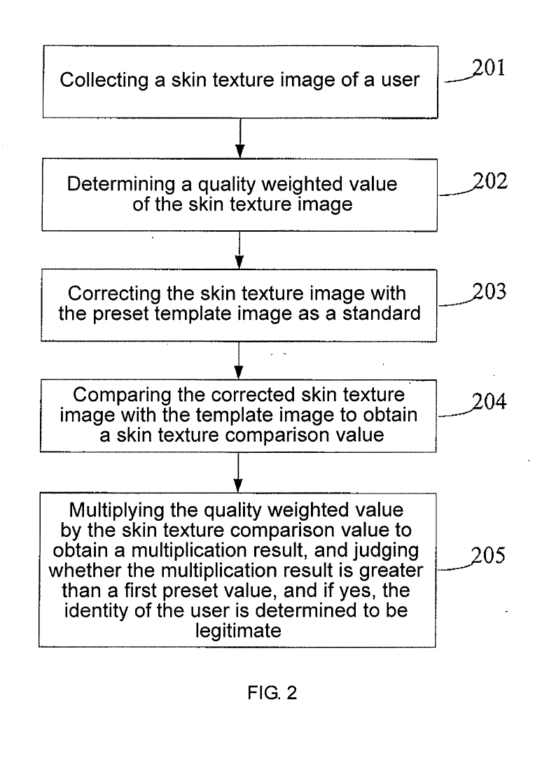

Reference is made to FIG. 2, which is a flow chart of another skin texture collection and identity recognition method disclosed in examples of this application.

In this example, the process of comparison of the skin texture image with the preset template image to determine the skin texture comparison value is defined.

As shown in FIG. 2, the method includes:

Step 201: collecting a skin texture image of a user

Particularly, the collection process may include that: first an active skin texture information collection module is contacted with a skin surface requiring the collection of skin texture, then a button on the collection module is clicked to get into a collection link, and when the collection is completed, a prompt is given by the system, indicating that the collection is completed. Herein, the collection sites may be various sites on the skin of human bodies such as the forehead, the back of the hand, and the leg; and the prompt given by the system may be a sound prompt, a light prompt or a prompt on the screen showing the termination, of course the prompt may also be any combination mode of these three forms.

Step 202: determining a quality weighted value of the skin texture image

Particularly, after the collection of the user's skin texture image, quality of the skin texture image can be judged, and corresponding images are all assigned with weighted values of the image quality. The weighted value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given.

Step 203: correcting the skin texture image with the preset template image as a standard

Particularly, the skin texture image is corrected by comparing the template image with the skin texture image. This correction includes angle correction or displacement correction, and of course, both angle and displacement may be corrected.

Step 204: comparing the corrected skin texture image with the template image to obtain a skin texture comparison value

Step 205: multiplying the quality weighted value by the skin texture comparison value to obtain a multiplication result, and judging whether the multiplication result is greater than a first preset value, and, if yes, determining that the identity of the user is to be legitimate.

Particularly, a first preset value should be prestored before the recognition, and the magnitude of the value is determined by the user according to multiple experiments. During the recognition, the skin texture image is corrected, and the quality weighted value of the image and the skin texture comparison value are taken into comprehensive consideration, and the relationship between the multiplication result of the two values and the magnitude of the first preset value is judged. When the multiplication result is greater than the first preset value, the identity of the user is determined to be legitimate, and the user is allowed to login, or else the identity of the user is determined to be illegitimate, and the user is rejected to login.

In this example, due to the facts that minutiae do not need to be emphasized excessively, and texture and large joints are emphasized, the problem that login is rejected due to the lack of the minutiae is reduced.

Further, in the above example, only one template image is prestored, and only one template image is compared with the collected image during the comparison, which case is suitable for use in personal service. Of course, on the occasion where identity authentication needs to be performed on a plurality of persons, like in a library etc., in the above example, skin image templates of the plurality of persons can be prestored, and during the authentication, it is correspondingly required to compare each of the template images with the collected skin texture image successively, and to select the maximum value among the multiple comparison results. Whether the maximum value is greater than a preset value or not is judged, and, if yes, than the identity of the user is determined to be legitimate and the user is allowed to login. Therefore, a 1:N authentication process is achieved.

The process of the above Step 204: comparing the corrected skin texture image with the template image to obtain the skin texture comparison value can be seen in the following method.

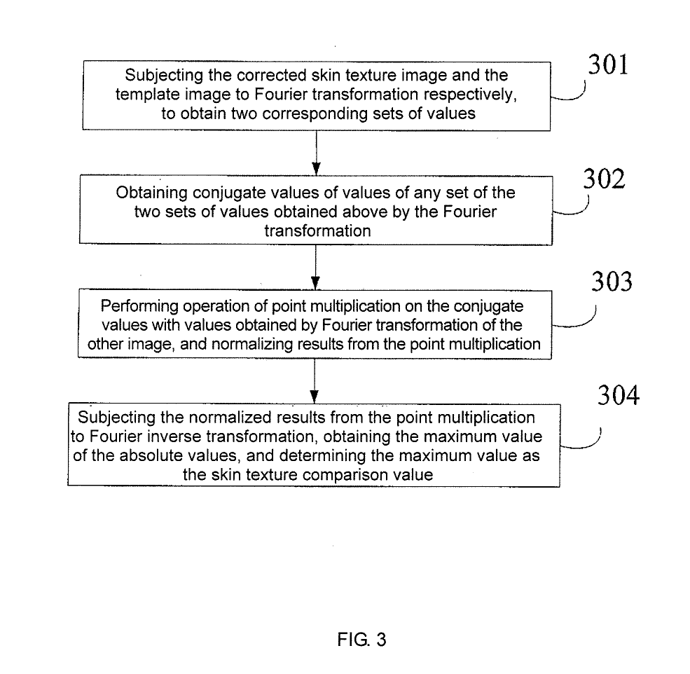

Reference is made to FIG. 3, which is a flow chart of comparison of a skin texture image with a template image disclosed in examples of this application.

This method includes:

Step 301: subjecting the corrected skin texture image and the template image to Fourier transformation respectively to obtain two corresponding sets of values;

Step 302: obtaining conjugate values of values of any set of the two sets of values obtained above by the Fourier transformation;

Step 303: performing operation of point multiplication on the conjugate values with values obtained by Fourier transformation of the other image, and normalizing results from the point multiplication; and

Step 304: subjecting the normalized results from the point multiplication to Fourier inverse transformation, obtaining the maximum value of the absolute values, and determining the maximum value as the skin texture comparison value.

In the comparison method of skin texture images provided in this example, a detection and analysis area having rich skin textures, fewer interferences from the hair and greater robustness to expression changes is selected, minutiae of the texture are not emphasized excessively, and thus the formidable and difficult problem with the current popular comparison methods of fingerprint minutiae, of login rejection due to fingerprint images with few or no minutiae, is solved. Also, this method is not only suitable for use in the verification and comparison of images on the front side and lateral side of a fingerprint, but also suitable for the verification and comparison of images on the front side of a knuckle, the back side of a knuckle, a palm, a face and the like.

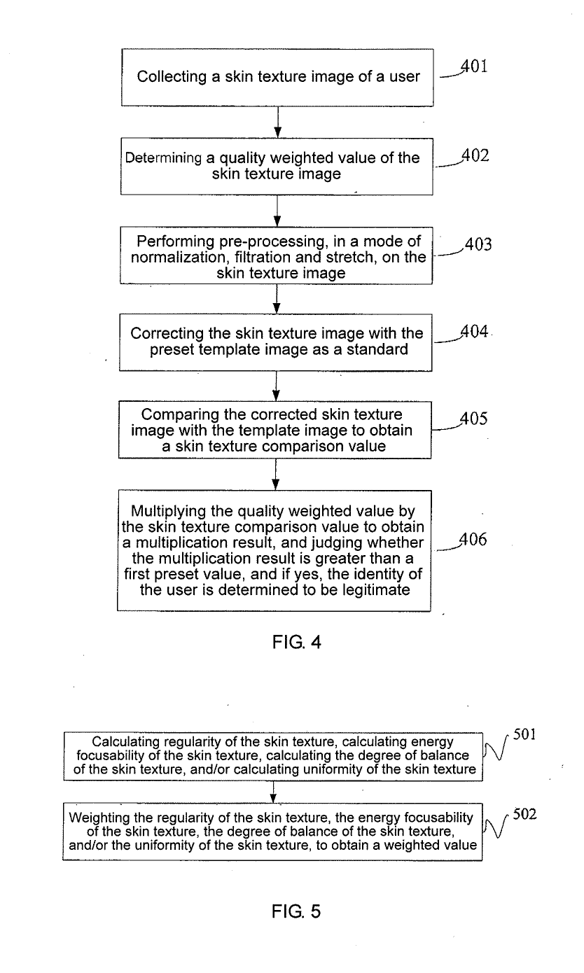

Reference is made to FIG. 4, which is a flow chart of yet another skin texture collection and identity recognition method disclosed in examples of this application.

As shown in FIG. 4, the Steps 401, 402, 404, 405, and 406 in this example are the same as the Steps 201, 202, 203, 204, and 205 in Example 1, except that a Step 403 is added between the Steps 202 and 203. Step 403: performing pre-processing, in a mode of normalization, filtration and stretch, on the skin texture image.

The pre-processing performed on the skin texture image enables the skin texture extracted to be more accurate, and allows the authentication method to be more accurate.

Reference is made to FIG. 5, which is a flow chart of a method for determining a quality weighted value of a skin texture image disclosed in examples of this application.

This method includes:

Step 501: calculating regularity of the skin texture, calculating energy focusability of the skin texture, calculating the degree of balance of the skin texture, and/or calculating uniformity of the skin texture; and

Step 502: weighting the regularity of the skin texture, the energy focusability of the skin texture, the degree of balance of the skin texture, and/or the uniformity of the skin texture, to obtain a weighted value.

In this example, any one or more of the above four judgement standards may be selected. If a plurality of judgement standards is selected, weighting treatment is carried out correspondingly on values obtained for each of the judgement standards. Finally, the magnitudes of the total weighted values are taken into comprehensive consideration, to evaluate the quality of the skin texture image.

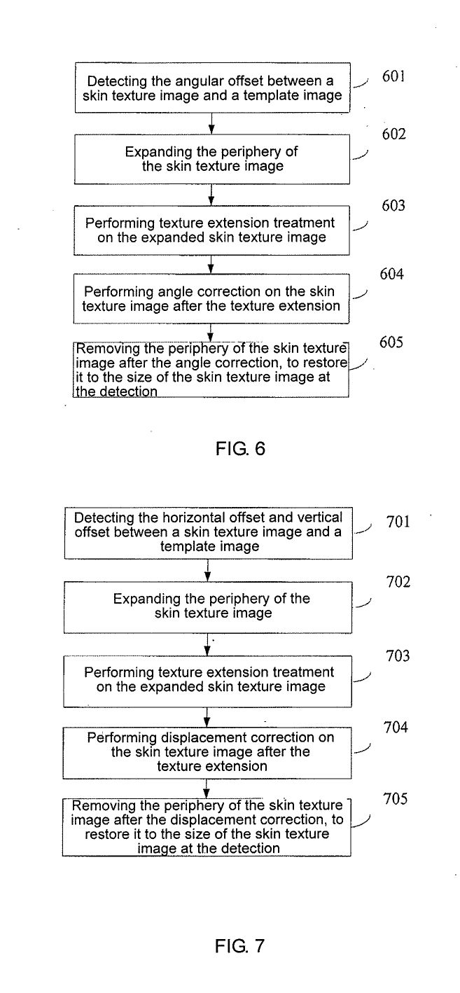

Reference is made to FIG. 6, which is a flow chart of a method of angle correction after texture extension of a skin texture image disclosed in examples of the application.

As shown in FIG. 6, the method includes:

Step 601: detecting the angular offset between the skin texture image and the template image;

Step 602: expanding the periphery of the skin texture image;

Step 603: performing texture extension treatment on the expanded skin texture image;

Step 604: performing angle correction on the skin texture image after the texture extension; and

Step 605: removing the periphery of the skin texture image after the angle correction to restore it to the size of the skin texture image at the detection.

In this step, periphery is removed from the texture image after the angle correction to restore it to the size of the initial skin texture image at the very beginning of the detection.

In this example, the angle correction is allowed to be more accurate by subjecting the texture image to texture extension treatment first, and then the angle correction.

Of course the above angle correction method is only one of numerous methods, and other various angle correction methods are also present. For example, the methods employed for the angle correction may include: a correction method by angle offset of a collected image, a correction method by angle offset of a template, and a respective correction method by equally distributed angle offset of a collected image and a template. Data padding modes may include a constant-value data padding mode, a circularly-moving data padding mode, a random data padding mode, and a data padding mode after texture extension. Interpolation modes may include a nearest neighbor interpolation method, a bilinearity interpolation method, and a polynomial interpolation method. Therefore, combinations of the above various situations exist, and can all serve as the angle correction method in examples of this application.

Reference is made to FIG. 7, which is a flow chart of a method of displacement correction after texture extension of a skin texture image disclosed in examples of this application.

As shown in FIG. 7, the method includes:

Step 701: detecting the horizontal offset and vertical offset between the skin texture image and the template image;

Step 702: expanding the periphery of the skin texture image;

Step 703: performing texture extension treatment on the expanded skin texture image;

Step 704: performing displacement correction on the skin texture image after the texture extension; and

Step 705: removing the periphery of the skin texture image after the displacement correction to restore it to the size of the skin texture image at the detection.

In this step, periphery is removed from the texture image after the displacement correction to restore it to the size of the initial skin texture image at the very beginning of the detection.

In this example, the displacement correction is allowed to be more accurate by subjecting the texture image to texture extension treatment first, and then the displacement correction.

Further, both angle correction and displacement correction may be performed on the image, such that the correction is more accurate. Of course, alternatively only angle correction or only displacement correction may be performed in order to save time.

Of course the above displacement correction method is only one of numerous methods, and other various displacement correction methods are also present. For example, the methods employed for the displacement correction may include a correction method by displacement offset of a collected image, a correction method by displacement offset of a template, and a respective correction method by equally distributed offset of a collected image and a template. Data padding modes may include a constant-value data padding mode, a circularly-moving data padding mode, a random data padding mode, and a data padding mode after texture extension. Therefore, combinations of the above various situations exist, and can all serve as the displacement correction method in the examples of this application.

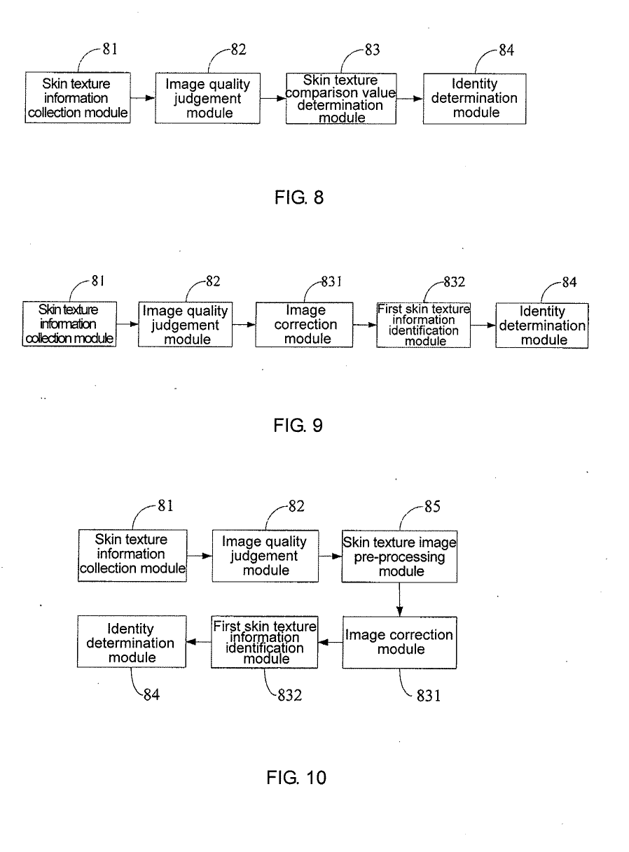

Reference is made to FIG. 8, which is a structural diagram of a skin texture collection and identity recognition system disclosed in examples of this application.

As shown in FIG. 8, the system includes:

a skin texture information collection module 81, configured to collect a skin texture image of a user; and

an image quality judgement module 82, connected with the skin texture information collection module, and configured to determine the quality weighted value of the skin texture image;

particularly, the image quality judgement module 82 is configured to evaluate the image quality, and assign a weighted value to each image. The value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given;

a skin texture comparison value determination module 83, connected with the image quality judgement module 82, and configured to compare the skin texture image with a preset template image, to determine a skin texture comparison value; and

an identity determination module 84, connected with the skin texture comparison value determination module 83, and configured to multiply the quality weighted value by the skin texture comparison value to obtain a multiplication result, and to judge whether the multiplication result is greater than a first preset value, and, if yes, to determine that the identity of the user is to be legitimate.

In this example, the image quality is judged by the image quality judgement module 82, and assigned with a certain weighted value. The skin texture image is compared by the skin texture comparison value determination module 83, to obtain a skin texture comparison value. The quality weighted value of the image and the skin texture comparison value are taken into comprehensive consideration, and the relationship between the multiplication result of the two values and the magnitude of the first preset value is judged. When the multiplication result is greater than the first preset value, the identity of the user is determined to be legitimate, and the user is allowed to login, or else the identity of the user is determined to be illegitimate, and the user is rejected to login.

Reference is made to FIG. 9, which is a structural diagram of another skin texture collection and identity recognition system disclosed in examples of this application.

In this system, the skin texture comparison value determination module 83 is subdivided.

As shown in FIG. 9, the system includes:

a skin texture information collection module 81, configured to collect a skin texture image of a user; and

an image quality judgement module 82, connected with the skin texture information collection module, and configured to determine the quality weighted value of the skin texture image;

particularly, the image quality judgement module 72 is configured to evaluate the image quality, and assign a weighted value to each image. The value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given;

an image correction module 831, connected with the image quality judgement module 82 and configured to correct the skin texture image with the preset template image as a standard;

a first skin texture information identification module 832, connected with the image correction module 831 and configured to compare the corrected skin texture image with the template image, to obtain a skin texture comparison value; and

an identity determination module 84, connected with the first skin texture information identification module 832, and configured to multiply the quality weighted value by the skin texture comparison value to obtain a multiplication result, and to judge whether the multiplication result is greater than a first preset value, and, if yes, to determine that the identity of the user is to be legitimate.

The system described in this example corrects the collected image by the image correction module 831 to allow the comparison process to be more accurate.

Reference is made to FIG. 10, which is a structural diagram of another skin texture collection and identity recognition system disclosed in examples of this application.

As shown in FIG. 10, on the basis of the above examples, this example may further include a skin texture image pre-processing module 85, with one end connected with the image quality judgement module 82 and the other end connected with the image correction module 831, and configured to pre-process the skin texture image.

The skin texture image is pre-processed by the skin texture image pre-processing module 85 to enable the skin texture extracted to be more accurate, and allow the authentication method to be more accurate.

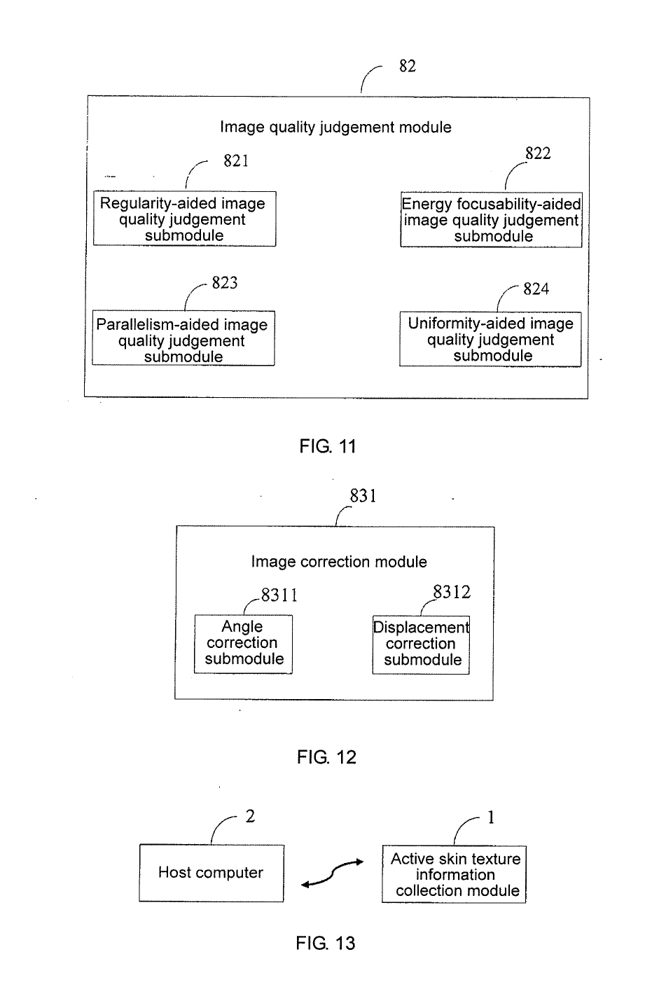

Reference is made to FIG. 11, which is a constitutional diagram of an image quality judgement module disclosed in examples of this application.

As shown in FIG. 11, the image quality judgement module 82 includes in particular:

a regularity-aided image quality judgement submodule 821, configured to perform judgement on the image quality in terms of regularity;

an energy focusability-aided image quality judgement submodule 822, configured to perform judgement on the image quality in terms of energy focusability;

a parallelism-aided image quality judgement submodule 823, configured to perform judgement on the image quality in terms of parallelism; and

a uniformity-aided image quality judgement submodule 824, configured to perform judgement on the image quality in terms of uniformity.

In this example, the image quality judgement module 82 may be any one or more of the regularity-aided image quality judgement submodule 821, the energy focusability-aided image quality judgement submodule 822, the parallelism-aided image quality judgement submodule 823, and the uniformity-aided image quality judgement submodule 824. Alternatively, a multimode image quality judgement module 82 may be constituted collectively by weighting. The regularity-aided image quality judgement submodule 821, the energy focusability-aided image quality judgement submodule 822, the parallelism-aided image quality judgement submodule 823, and the uniformity-aided image quality judgement submodule 824 provide different methods for judging the image quality, starting from local domain, global domain, frequency domain and time domain respectively of the image.

Herein, the regularity-aided image quality judgement submodule 821 means that the image quality is judged by regularity, that is, a degree of texture orderliness of the skin texture image is judged by texture regularity, which is a global index in the time domain. A skin texture image with a lower regularity has a scrambled texture, and a skin texture image with a higher regularity has an ordered arrangement of dermal ridges. The energy focusability-aided image quality judgement submodule 822 means that the image quality is judged by energy focusability, that is, the basic characteristics of the skin texture image is extracted in the frequency domain, and the energy focusability is a global index in frequency domain that embodies the part accounted by the dominant frequency. The parallelism-aided image quality judgement submodule 823 is an index for the judgement of a parallel degree of local dermal ridges on the skin texture image, and divides the skin texture image into equal pieces, where the skin texture image within each of the pieces generally consists of alternating ridge lines and valley lines. A skin texture image with good parallelism have ridge lines all in an approximately parallel direction, as is the case contrary to an image with poor parallelism. The uniformity-aided image quality judgement submodule 824 means the image quality is judged by uniformity. The texture uniformity is used to characterize the ratio of pixels at different degrees of gray levels in a local image of the skin texture, and is a local index in the time domain. Ridges and valleys of a skin texture image with good uniformity are alternately arranged and uniformly distributed, so that the ratio between black and white pixels within each piece is stable. Whereas in a skin texture image with poor uniformity, ridge and valley lines are not apparent, many miscellaneous cracks are present, and the variations across the pieces are very high, so that the ratio of pixels is not constant.

Reference is made to FIG. 12, which is a constitutional diagram of an image correction module disclosed in examples of this application.

As shown in FIG. 12, the image correction module 831 includes:

an angle correction submodule 8311 and a displacement correction submodule 8312.

Herein, the angle correction submodule 8311 is configured to prestore a template image as a standard and perform angle correction on the skin texture image collected; and the displacement correction submodule 8312 is configured to prestore a template image as a standard and perform displacement correction on the skin texture image collected.

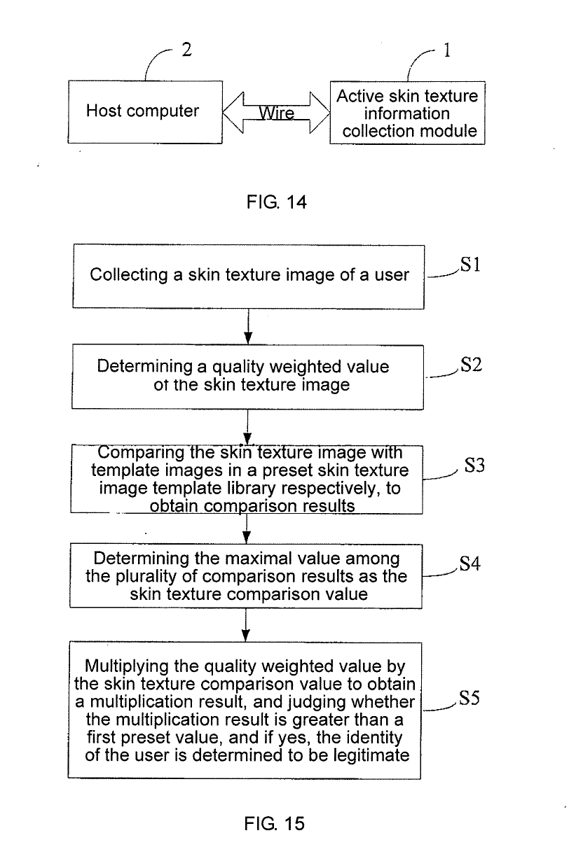

Reference is made to FIGS. 13 and 14. FIG. 13 is a schematic view of a skin texture information collection module and a host computer disclosed in examples of this application. FIG. 14 is a schematic view of another skin texture information collection module and a host computer disclosed in examples of this application.

Herein the skin texture information collection module 81 may be either an active skin texture information collection module, or a passive skin texture information collection module. Only the relationship between the active skin texture information collection module and the host computer is discussed here. The active skin texture information collection module is numbered as 1, and the host computer is numbered as 2. The collection module 1 and the host computer 2 accomplish together the collection of the skin texture, as well as authentication, and the subsequent work after the authentication.

As shown in FIG. 13, the active skin texture information collection module 1 and the host computer 2 are two units that are isolated from each other, and may have signal communication in a wireless form.

The active skin texture information collection module 1 may be designed as a structure convenient for holding in the hand. A user can be subjected to collection of the skin textures at various sites of the human body such as the forehead, neck, back and leg by the hand-held active skin texture information collection module 1, because the skin texture information collection module 1 is isolated from the host computer 2. Whereas a traditional passive skin texture information collection module is commonly fixed to a wall or other positions. It needs a person to actively place the site to be collected onto the collection module during the collection. The collection module is fixed during this process, and thus it is extremely difficult to carry out collection by the traditional collection mode for some special sites of the human body such as the neck and leg. Whereas this active skin texture information collection module 1 disclosed in this example is more flexible and convenient in use, and provides higher respect for the collection objects, as both the collection module and the human body are movable during the collection process.

As shown in FIG. 14, in this application, the active skin texture information collection module 1 can also be connected with the host computer 2 through a wire. In this case, within a range in which the wire is allowed to move, the active skin texture information collection module 1 can also collect textures at various sites of the human body.

Of course, in this application, the active skin texture information collection module 1 is not necessarily limited to the design as a hand-held structure, and it can also be installed on a three-dimensional mobile platform, or many other modes shall all fall within the protection scope of this application, so long as the collection module can move and rotate at different degrees of freedom during the collection process, namely the collection module is active.

In another example of this application there is provided another skin texture collection and identity recognition method. As different from the above method, this example provides another process in which a skin texture image is compared with a preset template image to determine a skin texture comparison value.

Reference is made to FIG. 15, which is a flow chart of another skin texture collection and identity recognition method disclosed in examples of this application.

The method includes:

Step S1: collecting a skin texture image of a user

A skin texture image input by the user is acquired by subjecting a specific skin area to image collection.

Step S2: determining a quality weighted value of the skin texture image

Particularly, after the acquisition of the skin texture image input by the user, quality of the skin texture image can be judged, and corresponding images are all assigned with weighted values of the image quality. The weighted value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given.

As for the particular way how to determine the quality weighted value, reference may be made to the discussion related to the method for determining a weighted value of the image quality, and the method used here is the same as that discussed before.

Step S3: comparing the skin texture image with template images in a preset skin texture image template library respectively to obtain comparison results, where the skin texture image template libraries include at least one template image

Particularly, skin texture image templates of one or more users can be prestored in the skin texture image template library. If a template of one user is prestored, it only needs to compare the skin texture image acquired with one template prestored. If templates of a plurality of users are prestored, it needs to compare each of the templates with the skin texture image acquired successively to obtain a plurality of comparison results.

Step S4: determining the maximal value among the plurality of comparison results as the skin texture comparison value

Particularly, the maximum value is determined among the plurality of comparison results, and determined as the skin texture comparison value.

Step S5: multiplying the quality weighted value by the skin texture comparison value to obtain a multiplication result, and judging whether the multiplication result is greater than a first preset value, and, if yes, determining that the identity of the user is to be legitimate.

Particularly, a first preset value should be prestored before the recognition, and the magnitude of the value is determined by the user according to multiple experiments. During the recognition, the quality weighted value of the image and the comparison value of the skin texture characteristics are taken into comprehensive consideration, and the relationship between the multiplication result of the two values and the magnitude of the first preset value is judged. When the multiplication result is greater than the first preset value, the identity of the user is determined to be legitimate, and the user is allowed to login, or else the identity of the user is determined to be illegitimate, and the user is rejected to login.

Further, the technical solutions according to this application can not only carry out the 1:1 verification, but also carry out the 1:N matching operation.

In this example, due to the facts that minutiae do not need to be emphasized excessively, and texture and large joints are emphasized, the problem that login is rejected due to the lack of the minutiae is reduced.

In the above example, Step S3: comparing the skin texture image with template images in a preset skin texture image template library respectively to obtain the comparison results, has a particular implementation process that can refer to a process as follows:

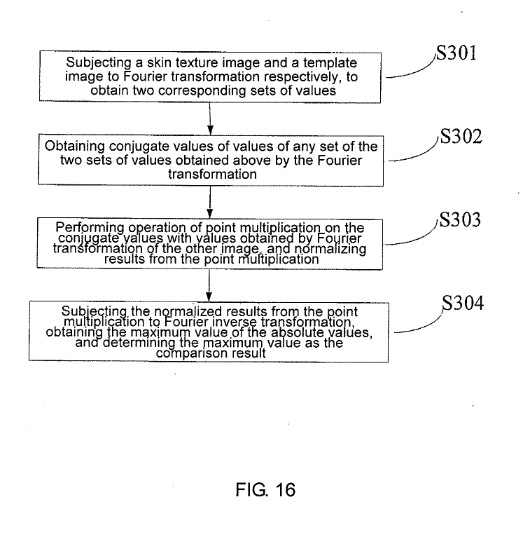

Reference is made to FIG. 16, which is a flow chart of comparison of a skin texture image with a template image disclosed in examples of this application.

The method includes:

Step S301: subjecting the skin texture image and the template image to Fourier transformation respectively to obtain two corresponding sets of values;

Step S302: obtaining conjugate values of values of any set of the two sets of values obtained above by the Fourier transformation;

Step S303: performing operation of point multiplication on the conjugate values with values obtained by Fourier transformation of the other image, and normalizing results from the point multiplication; and

Step S304: subjecting the normalized results from the point multiplication to Fourier inverse transformation, obtaining the maximum value of the absolute values, and determining the maximum value as the comparison result.

In the comparison method of skin texture images provided in this example, a detection and analysis area having rich skin textures, fewer interferences from the hair and greater robustness to expression changes is selected, minutiae of the texture are not emphasized excessively, and thus the formidable and difficult problem with the current popular comparison methods of fingerprint minutiae, of login rejection due to fingerprint images with few or no minutiae, is solved. Also, this method is not only suitable for use in the verification and comparison of images on the front side and lateral side of a fingerprint, but also suitable for the verification and comparison of images on the front side of a knuckle, the back side of a knuckle, a palm, a face and the like.

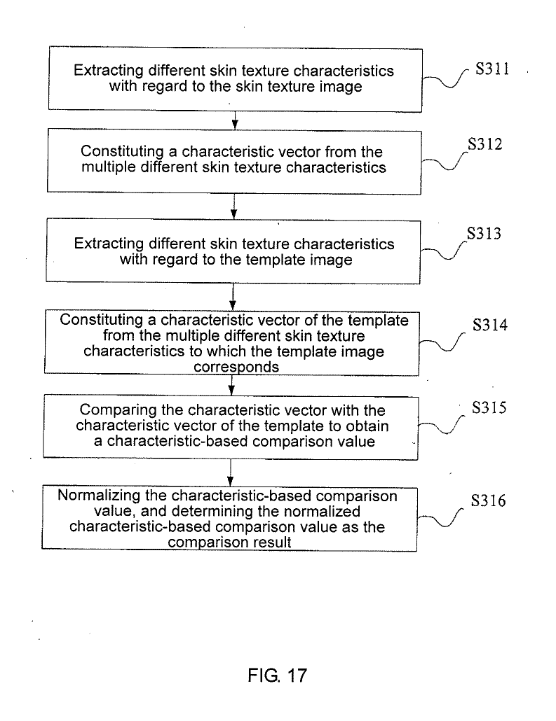

Reference is made to FIG. 17, which is a flow chart of yet another comparison of a skin texture image with a template image disclosed in examples of this application.

The method includes:

Step S311: extracting different skin texture characteristics with regard to the skin texture image;

Step S312: constituting a characteristic vector from the multiple different skin texture characteristics;

Step S313: extracting different skin texture characteristics with regard to the template image;

Step S314: constituting a characteristic vector of the template from the multiple different skin texture characteristics to which the template image corresponds;

Step S315: comparing the characteristic vector with the characteristic vector of the template to obtain a characteristic-based comparison value; and

Step S316: normalizing the characteristic-based comparison value, and determining the normalized characteristic-based comparison value as the comparison result.

Further, in this application, the characteristic vector of the template may also be prestored by the user, such that the characteristic vector of the template is extracted directly without Step S313 and Step 314. In this example, according to the extraction and comparison of characteristics of skin texture direction, frequency, fineness, depth, joint type, joint number, texture primitive number, texture primitive distribution, local characteristics and the like, minutiae of the texture are not emphasized excessively for a detection and analysis area having greater robustness to expression changes, and thus the formidable and difficult problem with the current popular comparison methods of fingerprint minutiae, of login rejection due to fingerprint images with few or no minutiae, is solved. Also, this method is not only suitable for use in the verification and comparison of images on the front side and lateral side of a fingerprint, but also suitable for the verification and comparison of images on the front side of a knuckle, the back side of a knuckle, a palm, a face and the like.

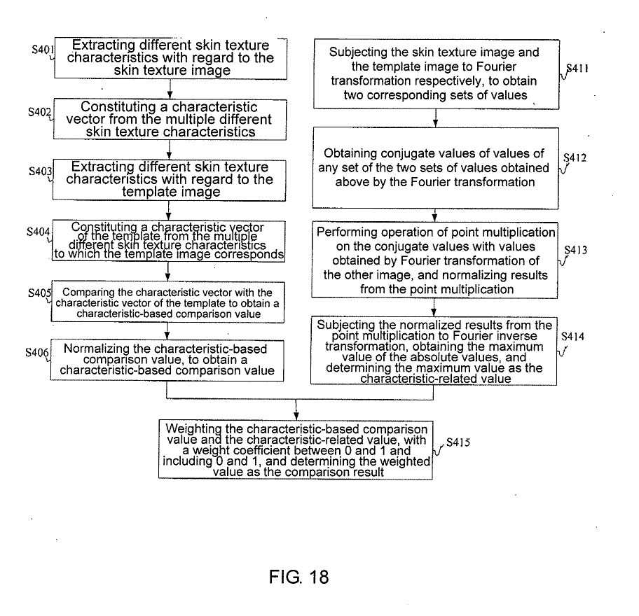

Reference is made to FIG. 18, which is a flow chart of a further comparison of a skin texture image with a template image disclosed in examples of this application.

The method includes:

Step S401: extracting different skin texture characteristics with regard to the skin texture image;

Step S402: constituting a characteristic vector from the multiple different skin texture characteristics;

Step S403: extracting different skin texture characteristics with regard to the template image;

Step S404: constituting a characteristic vector of the template from the multiple different skin texture characteristics to which the template image corresponds;

Step S405: comparing the characteristic vector with the characteristic vector of the template to obtain a characteristic-based comparison value;

Step S406: normalizing the characteristic-based comparison value to obtain a characteristic-based comparison value;

Step S411: subjecting the skin texture image and the template image to Fourier transformation respectively to obtain two corresponding sets of values;

Step S412: obtaining conjugate values of values of any set of the two sets of values obtained above by the Fourier transformation;

Step S413: performing operation of point multiplication on the conjugate values with values obtained by Fourier transformation of the other image, and normalizing results from the point multiplication;

Step S414: subjecting the normalized results from the point multiplication to Fourier inverse transformation, obtaining the maximum value of the absolute values, and determining the maximum value as the characteristic-related value; and

Step S415: weighting the characteristic-based comparison value and the characteristic-related value, with a weight coefficient between 0 and 1 and including 0 and 1, and determining the weighted value as the comparison result.

In this example, by comprehensive consideration of the two methods for comparing skin texture images, minutiae of the texture are not emphasized excessively for a detection and analysis area having greater robustness to expression changes, and thus the formidable and difficult problem with the current popular comparison methods of fingerprint minutiae, of login rejection due to fingerprint images with few or no minutiae, is solved. Also, this method is not only suitable for use in the verification and comparison of images on the front side and lateral side of a fingerprint, but also suitable for the verification and comparison of images on the front side of a knuckle, the back side of a knuckle, a palm, a face and the like.

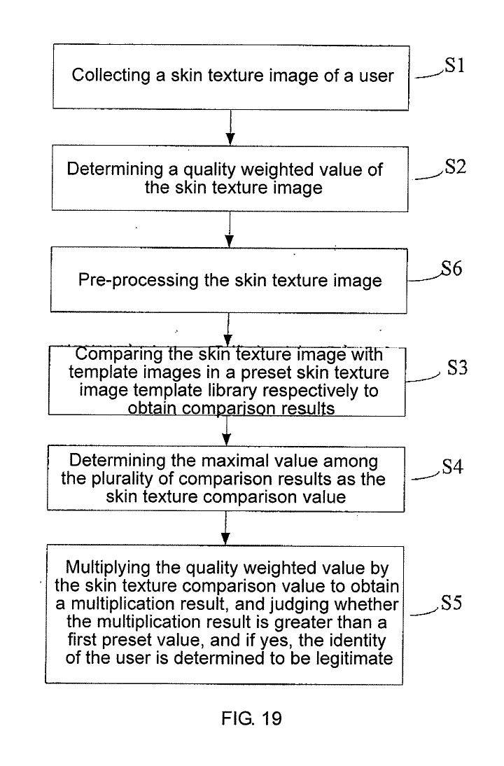

Reference is made to FIG. 19, which is a flow chart of another skin texture collection and identity recognition method disclosed in examples of this application.

In this example, Step S6: pre-processing the skin texture image, is added between the Step S2 and Step S3 of the example corresponding to FIG. 15, where the pre-processing mode includes: normalization, filtration, angle correction, displacement correction and stretch.

The pre-processing performed on the skin texture image enables the skin texture characteristics extracted to be clearer, and allows the authentication method to be more accurate.

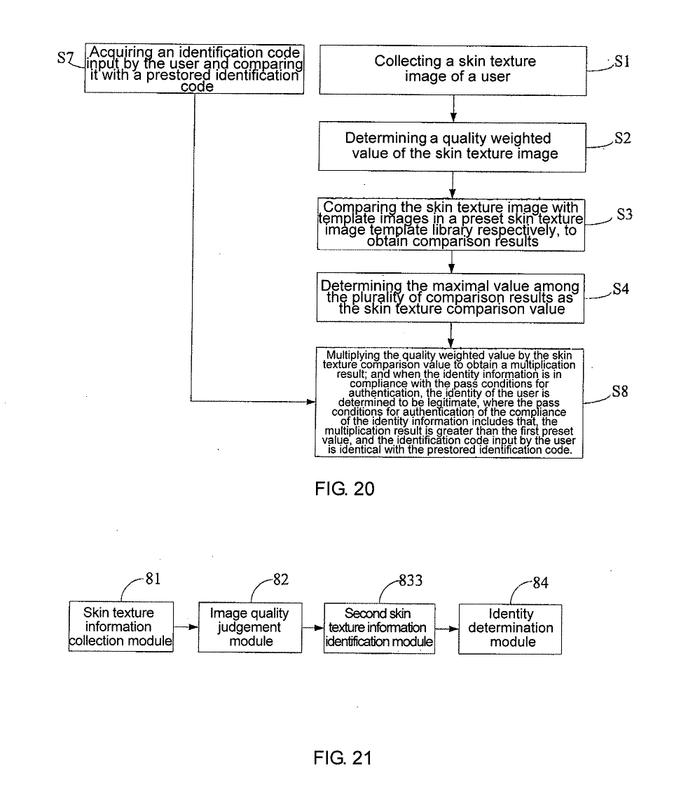

Reference is made to FIG. 20, which is a flow chart of another skin texture collection and identity recognition method disclosed in examples of this application.

This example is different from the previous example in that, Step S7: acquiring an identification code input by the user and comparing it with a prestored identification code, is added to the example corresponding to FIG. 15.

On the basis of this, the Step S5 in the example corresponding to FIG. 15 is correspondingly altered to Step S8: multiplying the quality weighted value by the skin texture comparison value to obtain a multiplication result; and when the identity information is in compliance with the pass conditions for authentication, the identity of the user is determined to be legitimate. The pass conditions for authentication of the compliance of the identity information includes that, the multiplication result is greater than the first preset value, and the identification code input by the user is identical with the prestored identification code.

In this example, a step of verification of the user's identification code is further added. The identification code may in particular include: a user name, a password, a job number, an ID card number, a cellphone, a terminal serial number and the like, and the read mode may be a touch and non-touch mode. The pass conditions for authentication when the identity of the user is finally determined includes: judgement of the recognition result of the texture characteristics and the result of the identity recognition code, and if the two results are both identical, the identity of the user is determined.

The identity recognition method based on the skin texture characteristics provided in this example employs a multimode manner to carry out recognition of the skin texture characteristics, and at the same time also carry out determination of the identification code, to allow the technical solutions according to this application to be safer and more reliable in use.

Also, the identity recognition method according to this application may be applied with the existing hardware resource, or may be applied with the hardware resource that has been subjected to a few modifications, so that there is no difficult problem with respect to the design and manufacture of the hardware.

Reference is made to FIG. 21, which is a structural diagram of another skin texture collection and identity recognition system disclosed in examples of this application.

In this example, the skin texture comparison value determination module 83 in FIG. 8 is defined as a second skin texture information identification module 833. A detailed structural diagram of the system includes the following:

a skin texture information collection module 81, configured to collect a skin texture image of a user;

an image quality judgement module 82, connected with the skin texture information collection module, and configured to determine the quality weighted value of the skin texture image;

particularly, the image quality judgement module 82 is configured to evaluate the image quality, and assign a weighted value to each image. The value is any number between 0 and 1, including 0 and 1. Of course, in order to increase the recognition speed, alternatively the weighted value of the image quality may be directly assigned as 1, without experiencing the image quality judgement process. If the image quality is too poor, it may choose to prompt the user to subject to the collection of skin texture again, or no prompt may be given. The particular structure of the image quality judgement module 82 may be seen in FIG. 11 and in the introduction thereof in the text;

a second skin texture information identification module 833, connected with the image quality judgement module 82 and configured to compare the skin texture image with template images in a preset skin texture image template library respectively to obtain comparison results, and determine the skin texture comparison value from the multiple comparison results; and

an identity determination module 84, connected with the second skin texture information identification module 833, and configured to multiply the quality weighted value by the skin texture comparison value to obtain a multiplication result, and to judge whether the multiplication result is greater than a first preset value, and, if yes, to determine that the identity of the user is to be legitimate.

The system described in this examples judges the image quality by the image quality judgement module 82, and assigns a certain weighted value. The skin texture image is compared by the second skin texture information identification module 833, to obtain a skin texture comparison value. The quality weighted value of the image and the skin texture comparison value are taken into comprehensive consideration, and the relationship between the multiplication result of the two values and the magnitude of the first preset value is judged. When the multiplication result is greater than the first preset value, the identity of the user is determined, and the user is allowed to login, or else the identity of the user is determined to be illegitimate, and the user is rejected to login.

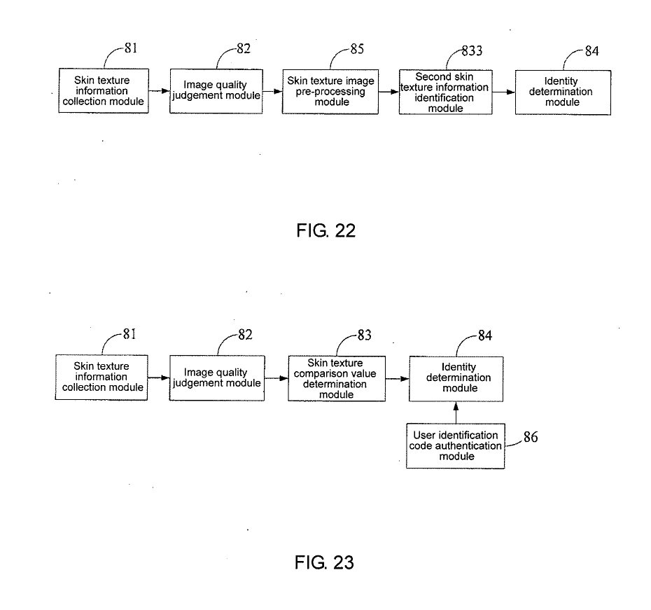

Reference is made to FIG. 22, which is a structural diagram of another skin texture collection and identity recognition system disclosed in examples of this application. On the basis of the above examples, this system may further include a skin texture image pre-processing module 85, with one end connected with the image quality judgement module 82 and the other end connected with a second skin texture information identification module 833, and configured to pre-process the skin texture image.

Reference is made to FIG. 23, which is a constitutional diagram of a further identity recognition system based on skin texture characteristics disclosed in this application.

On the basis of the example corresponding to FIG. 8, the system disclosed in this application further includes:

a user identification code authentication module 86, configured to receive an identification code input by a user and compare it with a prestored identification code for authentication.

Correspondingly, the effect of the identity determination module 84 in the example corresponding to FIG. 8 is also changed in that: the pass conditions for authentication to judge the compliance of the identity information further include: the multiplication result is greater than the first preset value, and the identification code input by the user is identical with the prestored identification code.

In this example, a user identification code authentication module 86 is further added, which is configured to receive an identification code input by a user, and compare it with a prestored identification code, thereby to obtain an authentication result of the identification code. Also, the pass conditions for authentication when the identity determination module 84 determines the user identity finally includes that, the multiplication result is greater than the first preset value, and the identification code input by the user is identical with the prestored identification code. Namely, the identity determination module 84 determines the user's identity through two aspects.

The identity recognition system based on skin texture characteristics provided in this example employs a multimode manner to carry out recognition of skin characteristics, and at the same time also carry out authentication of the identification code, to allow the technical solutions according to this application to be safer and more reliable in practical use.

Also, the identity recognition system according to this application may be applied with the existing hardware resource, or may be applied with the hardware resource that has been subjected to a few modifications, so that there is no difficult problem with respect to the design and manufacture of the hardware.

Finally, it needs to further state that, the terms such as “the first” and “the second” denoting the relationship herein are only used to distinguish one entity or operation from another entity or operation, but not necessarily to require or suggest that any such practical relationship or sequence is present between these entities or operations. Also, the terms “includes,” comprises,” or any other variants thereof are intended to encompass non-exclusive comprehension, thereby to allow a process, a method, an article or equipment including a series of elements to not only include those elements, but also further include other elements that are not listed explicitly, or further include elements inherent in this process, method, article or equipment. Without more limitation, an element defined by a statement “including one . . . ” dose not exclude the fact that other identical elements are also present in the process, method, article or equipment including that element.

Various examples in this specification are described progressively. The parts illustrated as emphases in each example are all what are different from other examples, and the same or similar parts among various examples can make reference to each other.

The above description of the examples disclosed enable those skilled in the art to realize or use this application. Various modifications to these examples will be apparent to those skilled in the art, and the general principles defined herein can be realized in other examples without departing from the spirit or scope of this application. Therefore, this application will not be limited to these examples shown herein, but shall be in compliance with the broadest scope in line with principles and novel features disclosed herein.

1. A skin texture collection and identity recognition method, characterized in that the method includes:
collecting a skin texture image of a user;
determining a quality weighted value of the skin texture image;
comparing the skin texture image with a preset template image to determine a skin texture comparison value; and
multiplying the quality weighted value by the skin texture comparison value to obtain a multiplication result, and judging whether the multiplication result is greater than a first preset value, and, if yes, determining that the identity of the user is to be legitimate.

2. The method according to claim 1, characterized in that the comparison of the skin texture image with the preset template image to determine the skin texture comparison value includes in particular:
correcting the skin texture image with the preset template image as a standard; and
comparing the corrected skin texture image with the template image to obtain the skin texture comparison value.

3. The method according to claim 2, characterized in that the collection of the skin texture image of the user includes in particular:
contacting an active skin texture information collection module with a skin surface requiring the collection of skin texture;
clicking a button to start the collection; and
giving a prompt by the system to indicate completion of the collection.

4. The method according to claim 2, characterized in that the process of the comparison of the corrected skin texture image with the template image to obtain the skin texture comparison value includes in particular:
subjecting the corrected skin texture image and the template image to Fourier transformation respectively to obtain two corresponding sets of values;
obtaining conjugate values of values of any set of the two sets of values obtained above by the Fourier transformation;
performing operation of point multiplication on the conjugate values with values obtained by Fourier transformation of the other image, and normalizing results from the point multiplication; and
subjecting the normalized results from the point multiplication to Fourier inverse transformation, obtaining the maximum value of the absolute values, and determining the maximum value as the skin texture comparison value.

5. The method according to claim 2, characterized in that, after the determination of the quality weighted value of the skin texture image, pre-processing, which includes normalization, filtration, and stretch of the skin texture image, is further included.

6. The method according to claim 2, characterized in that the correction of the skin texture image includes angle correction and/or displacement correction.

7. The method according to claim 1, characterized in that the comparison of the skin texture image with the preset template image to determine the skin texture comparison value includes in particular:
comparing the skin texture image with template images in a preset skin texture image template library respectively to obtain comparison results, wherein the skin texture image template libraries include at least one template image; and
determining the maximal value among the multiple comparison results as the skin texture comparison value.

8. The method according to claim 7, characterized in that the process of comparison of the skin texture image with the template images in the preset skin texture image template library respectively to obtain the comparison results includes in particular:
subjecting the skin texture image and the template image to Fourier transformation respectively to obtain two corresponding sets of values;
obtaining conjugate values of values of any set of the two sets of values obtained above by the Fourier transformation;
performing operation of point multiplication on the conjugate values with values obtained by Fourier transformation of the other image, and normalizing results from the point multiplication; and
subjecting the normalized results from the point multiplication to Fourier inverse transformation, obtaining the maximum value of the absolute values, and determining the maximum value as the comparison result.

9. The method according to claim 7, characterized in that the process of comparison of the skin texture image with the template images in the preset skin texture image template library respectively to obtain the comparison results includes in particular:
extracting different skin texture characteristics with regard to the skin texture image;
constituting a characteristic vector from the multiple different skin texture characteristics;
extracting different skin texture characteristics with regard to the template image;
constituting a characteristic vector of the template from the multiple different skin texture characteristics to which the template image corresponds;
comparing the characteristic vector with the characteristic vector of the template to obtain a characteristic-based comparison value; and
normalizing the characteristic-based comparison value and determining the normalized characteristic-based comparison value as the comparison result.

10. The method according to claim 7, characterized in that the process of comparison of the skin texture image with the template images in the preset skin texture image template library respectively to obtain the comparison results includes in particular:
extracting different skin texture characteristics with regard to the skin texture image;
constituting a characteristic vector from the multiple different skin texture characteristics;
extracting different skin texture characteristics with regard to the template image;
constituting a characteristic vector of the template from the multiple different skin texture characteristics to which the template image corresponds;
comparing the characteristic vector with the characteristic vector of the template to obtain a characteristic-based comparison value;
normalizing the characteristic-based comparison value to obtain a characteristic-based comparison value;
subjecting the skin texture image and the template image to Fourier transformation respectively to obtain two corresponding sets of values;
obtaining conjugate values of values of any set of the two sets of values obtained above by the Fourier transformation;
performing operation of point multiplication on the conjugate values with values obtained by Fourier transformation of the other image and normalizing results from the point multiplication;
subjecting the normalized results from the point multiplication to Fourier inverse transformation, obtaining the maximum value of the absolute values, and determining the maximum value as the characteristic-related value; and
weighting the characteristic-based comparison value and the characteristic-related value, with a weight coefficient between 0 and 1 and including 0 and 1, and determining the weighted value as the comparison result.

11. The method according to claim 7, characterized in that before the comparison of the skin texture image with the template images in the preset skin texture image template library respectively to obtain the comparison results, the following step is further included:
performing pre-processing, which includes normalization, filtration, angle correction, displacement correction, and stretch, on the skin texture image.

12. The method according to claim 7, characterized in that the determination of the quality weighted value of the skin texture image includes in particular:
calculating regularity of the skin texture, calculating energy focusability of the skin texture, calculating the degree of balance of the skin texture, and/or calculating uniformity of the skin texture; and
weighting the regularity of the skin texture, the energy focusability of the skin texture, the degree of balance of the skin texture, and/or the uniformity of the skin texture, to obtain a weighted value.

13. A skin texture collection and identity recognition system, characterized in that the system includes:
a skin texture information collection module, configured to collect a skin texture image of a user;
an image quality judgement module, connected with the skin texture information collection module, and configured to determine the quality weighted value of the skin texture image;
a skin texture comparison value determination module, connected with the image quality judgement module, and configured to compare the skin texture image with a preset template image, to determine a skin texture comparison value; and
an identity determination module, connected with the skin texture comparison value determination module, and configured to multiply the quality weighted value by the skin texture comparison value to obtain a multiplication result and to judge whether the multiplication result is greater than a first preset value, and, if yes, to determine that the identity of the user is to be legitimate.

14. The system according to claim 13, characterized in that the skin texture comparison value determination module includes: an image correction module and a first skin texture information identification module, wherein
the image correction module is connected with the image quality judgement module and configured to correct the skin texture image with the preset template image as a standard; and
the first skin texture information identification module is connected with the image correction module and configured to compare the corrected skin texture image with the template image to obtain the skin texture comparison value.

15. The system according to claim 14, characterized in that the system further includes:
a skin texture image pre-processing module, with one end connected with the image quality judgement module and the other end connected with the image correction module, configured to pre-process the skin texture image.

16. The system according to claim 14, characterized in that the image correction module includes: an angle correction submodule and a displacement correction submodule.

17. The system according to claim 14, characterized in that the skin texture information collection module is an active skin texture information collection module.

18. The system according to claim 17, characterized in that the active skin texture information collection module is connected to a host computer with a wireless mode or with a wire therebetween.

19. The system according to claim 13, characterized in that the skin texture comparison value determination module includes: a second skin texture information identification module connected with the image quality judgement module and configured to compare the skin texture image with template images in a preset skin texture image template library respectively to obtain comparison results, and to determine the skin texture comparison value from the multiple comparison results.

20. The system according to claim 19, characterized in that the system further includes:
a skin texture image pre-processing module, with one end connected with the image quality judgement module and the other end connected with the second skin texture information identification module, configured to pre-process the skin texture image.

21. The system according to claim 19, characterized in that the image quality judgement module includes:
a regularity-aided image quality judgement submodule, configured to perform judgement on the image quality in terms of regularity;
an energy focusability-aided image quality judgement submodule, configured to perform judgement on the image quality in terms of energy focusability;
a parallelism-aided image quality judgement submodule, configured to perform judgement on the image quality in terms of parallelism; and
a uniformity-aided image quality judgement submodule, configured to perform judgement on the image quality in terms of uniformity.
